(19) United States
(12) Patent Application Publication
(10) Pub. No.: US 2002/0142151 A1
(43) Pub. Date: Oct. 3, 2002

(54) Antireflection substrate with weak reflective color

(75) Inventors: Shinsuke Ochiai, Niihama-shi (JP); Kiyoshi Muto, Niihama-shi (JP)

Correspondence Address: SUGHRUE MION, PLLC, 2100 PENNSYLVANIA AVENUE, N.W., WASHINGTON, DC, 20037, US

(73) Assignee: SUMITOMO CHEMICAL COMPANY. LIMITED

(21) Appl. No.: 10/103,121

(22) Filed: Mar. 22, 2002

(30) Foreign Application Priority Data
Mar. 29, 2001 (JP) 2001-096094

(51) Int. Cl. B32B 17/10; B32B 5/16

(52) U.S. Cl. 428/328; 428/451; 428/520; 428/441; 428/331

(57) ABSTRACT

An antireflection substrate is provided, which has a base; an antireflection layer comprising a high refractive index layer (having a refractive index in a range of from 1.6 to 1.8) and a low refractive index layer (having a refractive index in a range of from 1.3 to 1.5), both refractive index layers being placed on one side of surface of the base in this order; and an antireflection layer comprising a low refractive index layer (having a refractive index in a range of from 1.4 to 1.5) placed on the other side of surface of the base. The antireflection substrate shows an excellent antireflection performance, has a weak interference color of reflecting light and can provide a screen image with little mottled pattern.

### BACKGROUND OF THE INVENTION

1. Field of the Invention

The present invention relates to an antireflection substrate. More specifically, the present invention relates to an antireflection substrate with a weak reflective interference color.

2. Description of Related Art

An antireflection substrate having an antireflection layer placed on its base has been widely used as an optics part. For example, are known an antireflection substrate which is constituted of its base and an antireflection layer consisting of a low refractive index layer placed on a surface of the base and an antireflection substrate which is constituted of its base and an antireflection layer consisting of a high refractive index layer and a low refractive index layer, both layers being stacked on a surface of the base in this order. The high refractive index layer used herein is a layer having a higher refractive index than that of the base, and the low refractive index layer used herein is a layer having a lower refractive index than that of the high refractive index layer. The antireflection layer consisting of the two layers, i.e., the high and low refractive index layers, serves antireflection performance in a single unit. The thickness of the high and low refractive index layers is usually adjusted respectively so that optical film thickness (n×d) of the layers, which is obtained by a refractive index (n) multiplied by a thickness (d), is about ¼ times (λ/4) or about ½ times (λ/2) as long as a visible light wavelength (λ).

It is known that an antireflection layer consisting of the two high and low refractive index layers has a problem in that the antireflection layer has strong refractive interference color, while being excellent in antireflection performance. That is while a reflectance at a certain wavelength (λ) of visible light decreases with the increased difference in refractive index between the two layers, at the same time a reflectance of the visible light having a wavelength other than the wavelength (λ) increases, which results in problems such that the reflecting light interferes and the antireflection layer is strongly colored in blue or violet so that a screen image or the like looks to have a different color from inherent one. Furthermore, such a strong reflective interference color results in another problem such that, even with a slight change in thickness of layers, the reflective interference color changes from red to violet or further to blue. Due to such a interference color change, the screen image or the like looks to have a mottled pattern with color irregularity and to have an ugly appearance. On the other hand, although an antireflection layer consisting of a single low refractive index layer has a weak reflective interference color with halftone, the antireflection layer is inferior in antireflection performance.

### SUMMARY AND OBJECTS OF THE INVENTION

The inventors of the present invention have conducted researches on development of an antireflection substrate not only showing an excellent antireflection performance but also having a reduced interference color. As a result, the present inventors have found that an antireflection substrate comprising a base, an antireflection layer having a low refractive index layer and an antireflection layer having high and low refractive index layers can make an antireflection substrate which has an excellent antireflection performance with a weak interference color. The present invention has been accomplished on the basis of this findings.

The present invention provides an antireflection substrate comprising:

a base;

an antireflection layer comprising a high refractive index layer having a refractive index in a range of from 1.6 to 1.8 and a low refractive index layer having a refractive index in a range of from 1.3 to 1.5, the high and low refractive index layers being placed on one side of surface of the base in this order; and

an antireflection layer comprising a low refractive index layer having a refractive index in a range of from 1.4 to 1.5 and being placed on the other side of surface of the base.

### BRIEF DESCRIPTION OF THE DRAWINGS

FIG. 1 is a schematic sectional view of an example antireflection substrate of the present invention.

FIG. 2 is a reflection spectrum of a whole antireflection substrate of the present invention (see, Example 1).

FIG. 3 is a reflection spectrum of an antireflection layer comprising high and low refractive index layers, the antireflection layer being provided in an antireflection substrate of the present invention (see, Example 1).

FIG. 4 is a reflection spectrum of an antireflection layer comprising a low refractive index layer, the antireflection layer being provided in an antireflection substrate of the present invention (see, Example 1).

FIG. 5 is a reflection spectrum of a whole antireflection substrate having high and low refractive index layers on both sides of surface thereof (see, Comparative Example 1).

FIG. 6 is a reflection spectrum of an antireflection layer having high and low refractive index layers, the antireflection layer being provided in an antireflection substrate (see, Comparative Example 1).

FIG. 7 is a reflection spectrum of a whole antireflection substrate having low refractive index layers on both sides of surface thereof (see, Comparative Example 2).

FIG. 8 is a reflection spectrum of an antireflection layer having a low refractive index layer, the antireflection layer being provided in an antireflection substrate (see, Comparative Example 2).

### DETAILED DESCRIPTION OF THE PRESENT INVENTION

An antireflection substrate of the present invention comprises:

a base;

an antireflection layer comprising a high refractive index layer and a low refractive index layer, both refractive index layers being placed on one side of surface of the base in this order; and

an antireflection layer comprising a low refractive index layer and being placed on the other side of surface of the base.

As described above, the high refractive index layer used herein is a layer having a higher refractive index than that of the base to be used with the high reflective index layer, and the low refractive index layer used herein is a layer having a lower refractive index than that of the high refractive index layer to be used with the low reflective index layer.

A base used in the preset invention may be any conventional base and a material of the base is not limited. For example, the base may an inorganic base such as that made of glass or an organic base such as that made of resin. Examples of the resin for the organic base include polyester resins such as acrylic resin, polysytrene resin, styrene-acrylic copolymer resin, polycarbonate resin and polyethylene terephthalate resin and cellulose resins such as triacetyl cellulose. The base may be transparent and/or may be colored with a colorant such as pigment and dye. Furthermore, the base may contain an additive such as an antioxidant and an ultraviolet absorber. The shape of the base is not limited and may be plate-like or a film-like one. The base may have a flat surface; a surface with depressions and projections on a fine scale which may be formed by an embossing finish; or a concave or convex surface such as that of a concave lens or a convex lens. The thickness of the base is not limited, and may be in a range of from about 0.5 mm to about 20 mm (for a plate-like base) or may be in a range of from about 0.01 mm to about 0.8 mm (for a film-like base).

On to such a base, an antireflection layer(described below) used in the present invention may be provided directly. Alternatively, the antireflection layer may be provided over a base having at least one layer other than the antireflection layer therebwtween. For example, a hard coat layer (or a damage resistant layer) is provided on at least one surface of a base and then an antireflection layer used in the present invention is superimposed onto the hard coat layer. The placement of the hard coat layer improves adhesion of the antireflection layer provided thereon so as to prevent the antireflection layer from peeling off from the base and also improves anti-abrasion resistance of the antireflection layer. The thickness of the hard coat layer may be in a range of from about 1 μm to about 50 μm. When the thickness of the hard coat layer is too small, the performance of the hard coat layer, for example improvement in surface hardness, may be insufficient and a reflectance of the resulting antireflection substrate may be away from the designed reflectance. On the other hand, when the thickness of the hard coat layer is too large, a defect such as breakage or cracking occurs with ease in the hard coat layer.

The hard coat layer used in the present invention may contain various kinds of additives such as an antioxidant, a stabilizer, a colorant, a polymerization initiator and a leveling agent. Furthermore, the hard coat layer may contain conductive fine particles and/or a surfactant so as to provide an antistatic property. Still furthermore, the hard coat layer may contain other kinds of additives and fine particles and the like to improve various physical properties.

The hard coat layer used in the present invention may be obtained in a known method. For example, a hard coat agent including a curable compound and a solvent is applied onto a surface of a base to form a layer thereof and then the layer is dried and cured to provide the hard coat layer.

An antireflection substrate in the present invention comprises antireflection layers placed directly or indirectly onto a base with at least one layer (such as a hard coat layer) other than the antireflection layers therebetween. One of antireflection layers comprises at least one layer and is placed on one side of surface of the base. Another antireflection layer comprises plural layers having a refractive index different from one another, and is placed on the other side of surface of the base.

In the present invention, at least two layers, i.e., a high refractive index layer and a low refractive index layer, are placed in this order onto one side of surface of a base to provide one antireflection layer thereon. The high refractive index layer may have a refractive index in a range of from 1.6 to 1.8, both limits being included. The high refractive index layer may be placed onto a base by a method in which a solution including a curable compound and a solvent is applied onto the base, is then dried to remove the solvent, and is then cured to prepare the resulting layer. The solution for preparing the high refractive index layer maybe a solution containing a solvent and a polymerizable compound which is able to provide a layer of which refractive index is in the above range of from 1.6 to 1.8; a solution containing a solvent, a polymerizable compound and particles with a refractive index of from 1.6 or higher; or a mixture of the solutions.

Examples of the polymerizable compound which is able to provide a layer of which refractive index is in the above range of from 1.6 to 1.8 include polymerizable organic compounds having an aromatic ring, an sulfur atom, a bromine atom or the like. Specifically, the examples of the polymerizable compound may be tribromophenylmethacrylate, bis (4-methacryloylthiophenyl) sulfide and the like. The polymerizable compound may be used singly or as a mixture in combination thereof. Furthermore, polymerizable compound may be used together with a compound having a refractive index lower than that of the polymerizable compound and having a high cross-linkability in order to reinforce the resulting layer and/or to adjust to have a desired refractive index. Examples of such cross-linkable compound with a relatively low refractive index may include a compound having at least two polymerizable functional groups. Specifically, the examples of such a cross-linkable compound may be a compound with at least two polymerizable carbon-carbon double bonds, such as a multifunctional acrylate (or meta-acrylate) compound with at least two groups selected from acryloyloxy group and methacryloyloxy group; and organosilicic compounds such as an alkoxy silane compound, a halogenosilane compound, an acyloxysilane compound and a silazane compound.

Examples of the particles with a refractive index of from 1.6 or higher include inorganic particles such as titanium oxide particles, tin oxide particles, antimony oxide particles, indium oxide particles, zirconium oxide particles, zinc oxide particles and the like. The particles may be used singly or as a mixture in combination thereof. The particles preferably have a refractive index of from 1.8 or lower. As described above, such particles can be used together with a polymerizable compound and an optional cross-linkable compound to provide a solution for a high refractive index layer, the solution being applied on/over a base, followed by being dried and cured.

The solvent contained in a solution for a high refractive index layer may be selected depending on the properties of a base on which the solvent is applied and the conditions of curing the resulting layer. The thickness of a high refractive index layer is preferably in a range of about 0.01 μm to about 0.5 μm, both limits included. When the thickness is too small or too large, it tends to be difficult for high refractive index layer to attain a good antireflection performance.

An antireflection substrate in the preset invention has at least two low refractive index layers. One of low refractive index layers, which may have a refractive index in a range of from 1.3 to 1.5 (both limits being included), is superimposed on the side of surface of a base on which the above-described high refractive index layer has been placed. Another low refractive index layer, which may have a refractive index in a range of from 1.4 to 1.5 (both limits being included), is placed on the other side of surface of the base. The above-described hard coat layer may be provided between the low refractive index layer and the base. These low refractive index layers, which are placed on an opposite side of a base to each other, may be both made of the same materials or may be made of different kinds of materials, as long as the layers have the above-described refractive indexes, respectively, i.e. the refractive index in the range of from 1.3 to 1.5 and the refractive index in the range of from 1.4 to 1.5. Both low refractive index layers preferably have a refractive index of 1.45 or lower.

The low refractive index layers may be placed by a method in which a film comprising a resin with a refractive index in the range of from 1.3 to 1.5 or the range of from 1.4 to 1.5, respectively, is attached on/over a base, or by a method in which a coating solution comprising such a resin is applied and then dried on/over a base. Examples of the resin include a resin having a fluorine atom in a monomer unit thereof. Specifically, examples of the resin include polytetrafluoroethylene, polyvinylindene fluoride, tetrafluoroethylene-ethylene copolymer, perflouropolyether and the like.

Alternatively, the low refractive index layers may be placed by a method in which a solution including a polymerizable or curable compound and a solvent is applied on/over the base, is then dried to remove the solvent, and then is cured to prepare the resulting layer(s). The solution for the low refractive index layers may be a solution containing a solvent, a polymerizable or curable compound which is able to provide a layer of which refractive index is in the range of from 1.3 to 1.5 or in the range of from 1.4 to 1.5; a solution containing a solvent, a polymerizable or curable compound and particles with a refractive index of from 1.5 or lower (preferably, particles with a refractive index of from 1.3 to 1.4, both limits included); or a mixture of the solution.

Examples of the polymerizable or curable compound which is able to provide a layer of which refractive index is in the range of from 1.3 to 1.5 or in the range of from 1.4 to 1.5 include an organosilicic compound and an organic compound having a polymerizable functional group and a fluorine atom. Examples of the organic compounds having a polymerizable functional group and a fluorine atom include 2-(perfluorobutyl)ethylacrylate, 2-(perfluorooctyl)ethylacrylate, 2-(perfluorobutyl)ethylmethacrylate, 2-(perfluorooctyl)ethylmethacrylate, 2-(perfluorooctyl)ethyltrimethoxysilane, 2-(perfluorpropyl)ethyltrimethoxysilane and the like. Examples of the organosilicic compound include alkoxysilane compounds, acyloxysilane compounds, halogenosilane compounds, silazane compounds and the like. The organosilicic compound may have a substituent group such as an alkyl group, an aryl group, a vinyl group, an allyl group, an acryloyloxy group, a meta-acryloyloxy group, and epoxy group, an amino group and a mercapto group. Examples of the curable organosilicic compound include alkoxysilane compounds such as tetramethoxysilane, tetraethoxysilane, methyltrimethoxysilane, phenyltrimethoxysilane, phenyltriethoxysilane, dimethyldimethoxysilane, dimethyldiethoxysilane, vinyltrimethoxysilane, vinyltriethoxysilane, γ-aminopropyltriethoxysilane, N-(β-aminoethyl)-γ-aminopropyltrimethoxysilane, N-(β-aminoethyl)-γ-aminopropylmethyldimethoxysilane, γ-mercaptopropyltrimethoxysilane, γ-mercaptopropylmethyldimethoxysilane, γ-methacryloyloxypropyltrimethoxysilane, γ-methacryloyloxypropylmethyldimethoxysilane, γ-glicidoxypropyltrimethoxysilane and γ-glicidoxypropylmethyldimethoxysilane; halogenosilane compounds such as tetraclorosilane and methyltrichlorosilane; silazane compounds such as hexamethyldisilazane; and the like.

The polymerizable or curable compounds may be used singly or as a mixture in combination thereof. Moreover, the polymerizable or curable compounds may be used together with a compound having a refractive index higher than that of the polymerizable or curable compounds and having a high cross-linkability to prepare a low refractive index layer in order to reinforce the resulting layer and/or to adjust to have a desired refractive index. Examples of such a cross-linkable compound with a high refractive index may include a compound having at least two polymerizable functional groups, which may be the same as used for preparing the high refractive index layer.

Examples of the particles having a refractive index of 1.5 or lower include silicon oxide particles, magnesium fluoride particles and the like. The particles may be used singly or as a mixture in combination thereof. As described above, such particles can be used together with the polymerizable and/or cross-linkable compound to provide a solution for a low refractive index layer, the solution being applied on an appropriate surface, followed by being dried and cured.

A solvent for low refractive index layers may be selected depending on the properties of a base on which the solvent is applied and the conditions of curing the resulting layer. The thickness of both low refractive index layers (one of which may be placed on the same side of surface of a base as the high refractive index layer and the other of which may be placed on the opposite side of surface of the base to the high refractive index layer) are preferably in a range of about 0.01 μm to about 0.5 μm, both limits included. When the thickness is too small or too large, it tends to be difficult for the low refractive index layers to attain a good antireflection performance.

It is noted that each thickness, such as a thickness of a hard coat layer, a thickness of a high refractive index layer, a thickness of the low refractive index layer placed on/over the high refractive index layer and a thickness of a low refractive index layer placed on the opposite side of surface of a base to the high refractive index layer, may be measured from a wavelength exhibiting the lowest reflectance of the corresponding layer, the layer being placed individually. Alternatively, the thickness may be measured from a reflection spectrum of the each layer in a certain wavelength range, for example, in a range of from 400 nm to 800 nm.

As described above, the antireflection substrate in the present invention has, on one surface of abase, an antireflection layer comprising a high refractive index layer and a low refractive index layer in this order with an optional layer such as a hard coat layer between the base and the high refractive index layer and has, on the other side of surface of the base, an antireflection layer comprising a low refractive index layer with an optional layer such as a hard coat layer therebetween. The present invention has advantages especially when the antireflection layer comprising the high refractive index layer and the low refractive index layer has a large difference in refractive index between the high and low refractive index layers. For example, it is known that an antireflection substrate comprising an antireflection layer having a high refractive index layer and a low refractive index layer has a color change of the reflective interference light so that a screen image looks to have a mottled pattern with color irregularity, while the antireflection layer has a large difference in refractive index between the high and low refractive index layers. However, the antireflection substrate in the present invention has little color change of the reflective interference light and prevents a screen image from having a mottled pattern with color irregularity, even though the antireflection substrate has the antireflection layer comprising the high and low refractive index layers. Specifically, the advantages may be more effective when the difference in refractive index between the high and low refractive index layers is 0.25 or more, and may be the most effective in a case that the difference in refractive index is 0.26 or more.

When one low refractive index layer placed on/over a base and the other low refractive index layer placed on the side (of surface of the base) opposite to the former one are both made of the same materials, the two low refractive index layers may be placed by a method in which, after the high refractive index layer is placed on one side of surface of the base, a solution for preparing the low refractive index layers is applied on both sides of surface of the base, followed by being dried and cured. When the two low refractive index layers are made of different kinds of materials, the low refractive index layers may be placed by a method in which, after the high refractive index layer is placed on one side of surface of the base, different kinds of solutions for preparing the low refractive index layers are applied respectively on each side of surface of the base, followed by being dried and cured. Alternatively, as described above, one or both low refractive index layer(s) may be prepared from resin film or the like.

The solutions for preparing a hard coat layer, a high refractive index layer and a low refractive index layer may be applied on/over a base in a known method such as a microgravure coating method, a roll coating method, a dip coating method, a spin coating method, a die coating method, a spray coating method and a flow coating method. When a high refractive index layer and/or a low refractive index layer are prepared using a solution including a polymerizable compound and/or a curable compound, the layers are completed by being dried and cured after the solution was applied. A method for the curing may be selected depending on a kind of the solutions for preparing the high and low refractive index layers. Examples of the curing method include an irradiation method with visible light, ultraviolet light, an electron beam or the like, and a heating method. The curing of the high refractive index layer may be conducted before the solution for the low refractive index layer is applied and dried thereon, or may be conducted at the same time as the low refractive index layer is cured after the solution for the high refractive index layer is applied and dried and then the solution for the low refractive index layer is applied and dried.

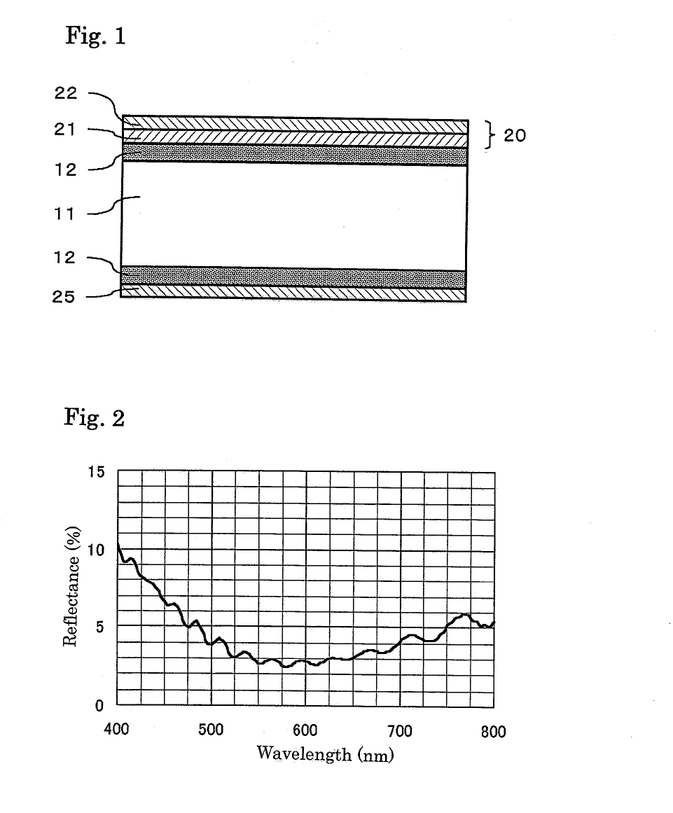

Referring now to FIG. 1, an example antireflection substrate of the present invention is described as follows, which should not be construed as a limitation upon the scope of the present invention. FIG. 1 is a schematic sectional view of the example antireflection substrate of the present invention. In this example, on one side of surface of base 11, high refractive index layer 21 and low refractive index layer 22 are stacked in this order to prepare antireflection layer 20, while on the other side of surface of base 11, low refractive index layer 25 is placed singly to prepare another antireflection layer. Base 11 may be a glass plate or a resin plate. On both surfaces of base 11, are placed hard coat layers 12, 12. Hard coat layers 12, 12 are preferably provided on both surfaces of base 11, which are not essential. No hard layer may be provided, or hard layer 12 may be provided only on one surface of base 11. High refractive index layer 21 has a refractive index of from 1.6 to 1.8, low refractive index layer 22 has a refractive index of from 1.3 to 1.5 and low refractive index layer 25 has a refractive index of from 1.4 to 1.5.

As described above, an antireflection substrate of the present invention shows an excellent antireflection performance, has a weak interference color of reflecting light and can provide a screen image with little mottled pattern of the reflecting light. Therefore, the antireflection substrate is useful for use in display applications such as a front panel of a projection television, a front panel of a plasma display and a member of an outmost front panel of a liquid crystal display; optics parts such as an optical lens, a spectacle lens and a light-guideing plate; a show window glass; and the like.

The entire disclosure of the Japanese Patent Application No. 2001-96094 filed on Mar. 29, 2001 indicating specification, claims, drawings and summary, is incorporated herein by reference in its entirety.

The invention being thus described, it will be apparent that the same may be varied in many ways. Such variations are to be regarded as within the spirit and scope of the invention, and all such modifications as would be apparent to one skilled in the art are intended to be within the scope of the following claims.

The present invention is described in more detail by following Examples, which should not be construed as a limitation upon the scope of the present invention.

It is noted that in Examples and Comparative Examples amounts of material are expressed in part(s) by weight unless otherwise described. Reflection spectra of the antireflection substrates obtained in Examples or Comparative Examples and reflection spectra of the antireflection layers placed in the antireflection substrates were measured by the following method:

A rear-surface treatment was conducted on a surface of an antireflection substrate, the surface being opposite to the surface (of the antireflection substrate) on which the antireflection layer to be measured was placed. After the rear-surface treatment, an absolute specular reflection spectrum of the antireflection layer was measured at an incident angle of 5° using a ultraviolet-visible light spectrophotometer “UV-3100” (manufactured by Shimadzu Corporation). The above-described rear-surface treatment was conducted in a way such that the surface (to be treated) of the antireflection substrate was roughened with steel wool, then a black paint was applied thereon and then the roughened surface with the paint was dried. On the other hand, an absolute specular reflection spectrum of the whole antireflection substrate, which includes the antireflection layers placed on both sides of surface of the antireflection substrate, was measured at an incident angle of 5° using the above spectrophotometer without conducting the rear-surface treatment. Thus obtained absolute specular reflection spectra are used as reflection spectra of the antireflection substrates and the antireflection layers in Examples or Comparative Examples.

### EXAMPLE 1

(1) Placement of Hard Coat Layer

Into 53.6 parts of a hard coat agent (“Sumicefine R-311” made by Sumitomo Osaka Cement K.K.) including conductive particles, were added and mixed 6.9 parts of dipentaerythritolhexaacrylate (“NK Ester A9530” made by Shin-Nakamura Kagaku K.K.), 10.8 parts of methylethylketone and 24.2 parts of diacetone alcohol, to prepare a hard coat agent. Thus prepared hard coat agent was applied on both sides of surface of an acrylic resin plate (“Sumipecks E” made by Sumitomo Chemical Co., Ltd.) having a thickness of 2 mm by a dip coating method at a pull speed of 50 cm/min, was dried at 40° C. for 10 min and was irradiated with an ultraviolet light, to place hard coat layers.

(2) Placement of High Refractive Index Layer

On one side of surface of the acrylic resin plate (prepared above in step (1)), which has the hard coat layers on both sides of the surface thereof, was attached a protective film (“Protect Tape #622B” made by Sekisui Chemical Co., Ltd.) so as not to form a film of a coating composition applied bellow.

A coating composition for a high refractive index layer was prepared by mixing 0.58 part of pentaerythritoltriacrylate, 0.09 part of tetraethoxysilane, 1.01 parts of zirconium oxide particles with an average primary particle diameter of 0.01 μm, 0.12 part of 1-hydroxycyclohexylphenylketone (as a polymerization initiator) and 98.2 parts of isobutyl alcohol (as a solvent). The coating composition was applied onto the acrylic resin plate (with the hard coat layers and the protective film thereon) in a dip coating method at a pull speed of 50 cm/min and was dried at 40° C. for 10 min, followed by being irradiated with ultraviolet light so that a high refractive index layer was formed on the side of surface (of the acrylic resin plate) with no protective film. The refractive index of the high refractive index layer was 1.73.

(3) Placement of Low Refractive Index Layer

A coating composition for a low refractive index layer was prepared by mixing 2 parts of tetraethoxysilane, 96 parts of ethanol (as a solvent) and 2 parts of 0.1 N hydrochloric acid solution (which is an aqueous solution containing HCl in an amount of 0.1 mol per 1000 cm³). After the protective film was peeled off from the surface of the acrylic resin plate (prepared above in step (2)), the coating composition for a low refractive index layer was applied onto the acrylic resin plate in a dip coating method at a pull speed of 50 cm/min, was dried at a room temperature for 5 min and was heated at 80° C. for 20 min, so that low refractive index layers were formed on both sides of surface of the acrylic resin plate. The refractive index of the low refractive index layers was 1.44.

By steps (1)-(3), was obtained an antireflection substrate comprising the acrylic resin plate, the hard coat layers, the high refractive index layer and low refractive index layers, the hard coat layers being placed on both sides of surface of the acrylic resin plate, the high refractive index layer and low refractive index layer being stuck in this order to provide a refractive index layer on one side of the surface of the acrylic resin plate and the low refractive index layer being stuck to provide another refractive index layer on the other side of the surface of the acrylic resin plate.

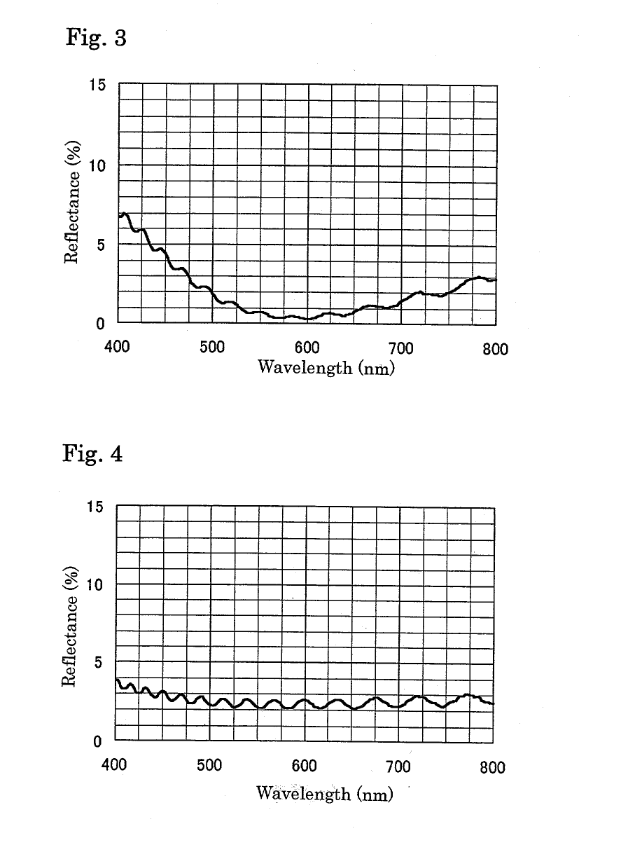

A reflection spectrum of the whole antireflection substrate was measured and is shown in FIG. 2. Also, reflection spectra of the antireflection layers, i.e., the antireflection layer comprising the high and low refractive index layers and the antireflection layer comprising the low refractive index layer, were measured and are shown in FIGS. 3 and 4, respectively. The obtained antireflection substrate has a weak refractive interference color of bluish violet close to a halftone on all over the surface thereof. Little or no mottled pattern due to the interference color was observed.

### COMPARATIVE EXAMPLE 1

An antireflection substrate was obtained in the same way as in Example 1 except that in step (2) no protective film was attached on the hard coat layer on one side of the acrylic resin plate before applying the coating composition for the high refractive index layer, so as to form the high refractive index layers on both sides of the acrylic resin plate. The obtained antireflection substrate had the antireflection layers, each of which comprises the low and high refractive index layers and hard coat layer, on both sides of surface of the acrylic resin plate.

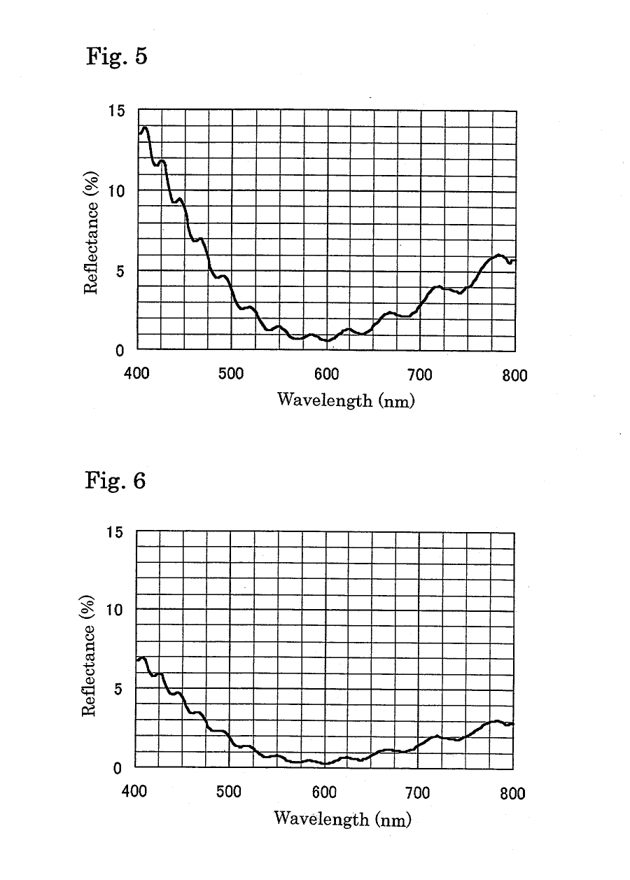

A reflection spectrum of the whole antireflection substrate was measured and is shown in FIG. 5. Also, a reflection spectrum of the antireflection layer placed on one side of surface of the acrylic resin plate was measured and is shown in FIG. 6. The obtained antireflection substrate has a strong interference color of bluish violet on all over the surface thereof. A conspicuous mottled pattern due to the interference color was observed very much.

### COMPARATIVE EXAMPLE 2

Steps (1) and (3) as in Example 1 were conducted to obtain an antireflection substrate having the low refractive index layers on the hard coat layers on both sides of surface of the acrylic resin plate with no high refractive index layer.

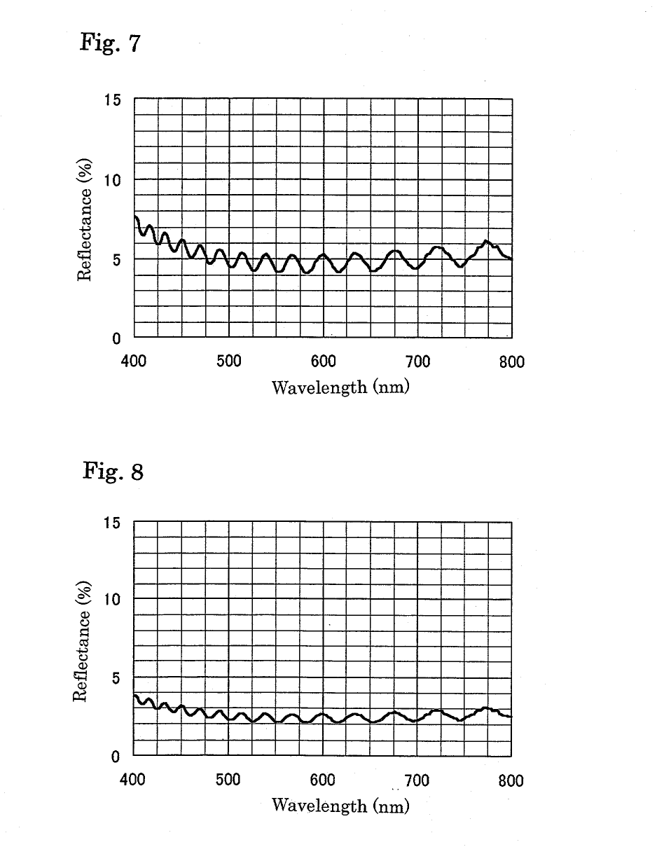

A reflection spectrum of the whole antireflection substrate was measured and is shown in FIG. 7. Also, a reflection spectrum of the antireflection layer placed on one side of surface of the acrylic resin plate was measured and is shown in FIG. 8. The obtained antireflection substrate has a weak interference color of bluish violet on all over the surface with almost no coloring. Little or no mottled pattern due to the interference color was observed. However, reflectance on the surface of the antireflection substrate was strong, by which images of things surrounding the substrate were reflected thereon. The antireflection substrate shows poor antireflection performance.

What is claimed is:

1. An antireflection substrate comprising:
a base;
an antireflection layer comprising a high refractive index layer having a refractive index in a range of from 1.6 to 1.8 and a low refractive index layer having a refractive index in a range of from 1.3 to 1.5, the high and low refractive index layers being placed on one side of surface of the base in this order; and
an antireflection layer comprising a low refractive index layer having a refractive index in a range of from 1.4 to 1.5 and being placed on the other side of surface of the base.

2. The antireflection substrate according to claim 1, further comprising at least one hard coat layer on at least one side of surface of the base, the hard coat layer being placed between the base and either one of the antireflection layers.
